(19) United States
(12) Patent Application Publication
(10) Pub. No.: US 2014/0290119 A1
(43) Pub. Date: Oct. 2, 2014

(54) HIGHLY EFFECTIVE FISHING SPOON LURE WITH COST EFFECTIVE FABRICATION

(71) Applicant: Shinzo Onishi, (US)

(72) Inventor: Shinzo Onishi, (US)

(21) Appl. No.: 13/854,917

(22) Filed: Apr. 1, 2013

(51) Int. Cl. A01K 85/14

(52) U.S. Cl. CPC A01K 85/14
USPC 43/42.52

(57) ABSTRACT

Fishing needs baits and especially live baits are very attractive, however, availability of live baits is unpredictable. So artificial fishing lures are a sure way to successful fishing. One of the most popular lures is a fishing spoon for predatory fish. In addition to classic squid spoons, many variations are widely used. The new invented spoon has only two parts, a flat semi-rigid spoon body and a hook. Although the two parts are assembled without any tools, effectiveness of the spoon is no less than the best spoon available. The punched thin metal or plastics spoon body remains flat without a hook. The spoon body with a hook forms gentle curved shape which mimics bait fish swimming at high speed when trolling. The cost of the invented spoon is a fraction of the prior art fishing spoons.

### BACKGROUND

Artificial fishing lures have been widely used and they specifically and effectively have been targeting for certain species; however, making effective lures are complex and time-consuming. In result, they are expensive. A squid spoon is one of the most popular artificial lures for trolling or from fishing piers and shores. Spoons have been used for many decades, and variations of color and others enhance their effectiveness recently. A white painted spoon body has been widely used today. Changing color of the spoon body among shiny chrome plate, shiny aluminum and white paint enhances yield.

### BACKGROUND OF THE INVENTION

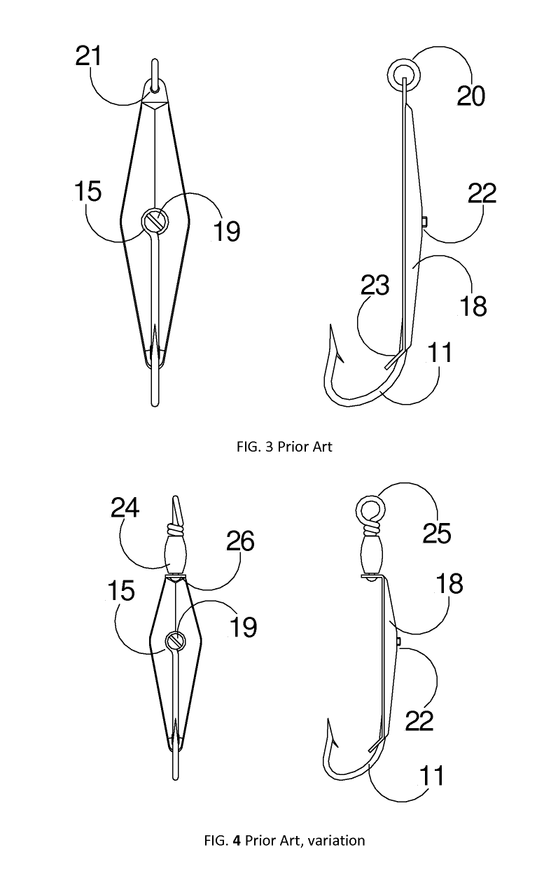

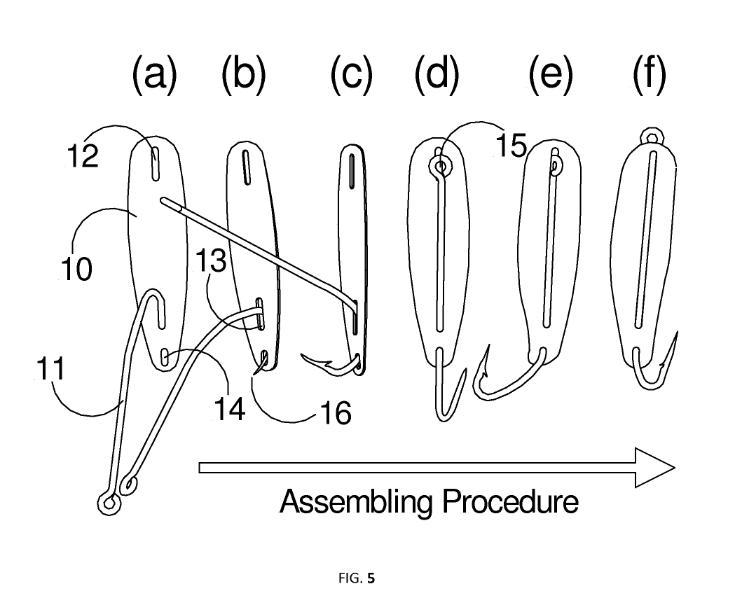

The bodies of prior art, traditional squid spoons as shown in FIG. 3 and FIG. 4 have been made with multi-layered electroplates on diamond shaped brass plates. A hook has been placed on the spoon body 18 with a small screw 19 or by other means. The parts of the prior art squid spoon are made by 4 components:
1) Body of the spoon 18: 2 holes 21, 23 and one screw hole 22, punched brass with electroplate,
2) A hook 11,
3) Pan head screws 19, and
4) Hard soldered end ring 20 through an end hole 21 of the spoon body 18

The assembly of the spoon body and a hook variations are: The screw is either replaced by rivet or hard solder. The original squid spoons FIG. 3 and FIG. 4 are beautiful shiny pieces; however, predatory fish may not have any recognition of beauty but they rather react on the shape of a small bait fish in motion. The required fabrication facilities of the traditional spoon are:
1) Stumping and diamond shaping 0.9 mm thick brass sheet 18,
2) Electroplating facility, copper followed by chrome on the spoon body 18
3) Tapping machine,
4) Hard solder system for closed loop of the end ring 20 and
5) A screw 19 in the place through an eyehole of a hook 15 to a tap screw hole 22 of the spoon body 18.

### SUMMARY OF THE INVENTION

The new invented spoon which has only two components is equally effective at a fraction of fabrication cost compared with traditional, prior art spoons and other variations. The spoon body has been made of white plastic or a thin metal sheet which is somewhat flexible. Fabrication of new invention trolling spoon lure needs only a metal punch and a hook which are widely available in the market. The hook attached to a screw or rivet is eliminated, so that assembling is far easier than that of a traditional spoon fishing lure. A new invention dramatically simplifies the fabrication of trolling fishing spoon. The three elongated top 12, middle 13 and bottom 14 holes enable tool less assembly as shown in FIG. 2. The hook 11 is pushed into three holes: 12, 13 and 14 using a semi-flexible spoon body 10. The flat and semi-ridged spoon body 10 is shaped as a gently curved 17 by a ridged hook 11. The curved spoon body 17 simulates a small bait fish swimming at high speed in the water. The eye 15 of the hook is directly connected to a 1-2 m leader line, so the lure is very strong and reliable without a rivet or a screw. The effectiveness of the invented fishing spoon has been as good as the best squid spoon in the market. While the hook is made with a saltwater resistant metal, aluminum or plastic spoon body requires no strength due to the direct connection from the leader to an eye hole 15 of a hook. The lure has a 1-2 meter leader and a heavy sink which keeps the desired distance from the surface of water. The spoon body bears far less weight compared with the sink so the spoon and sink separate with each other when casting the lure. In result, the spoon may not tangle with the sink compared with the traditional heavy spoon. The new spoon is an environmentally benign product without chemicals.

### BRIEF DESCRIPTION OF THE DRAWINGS

### Drawings

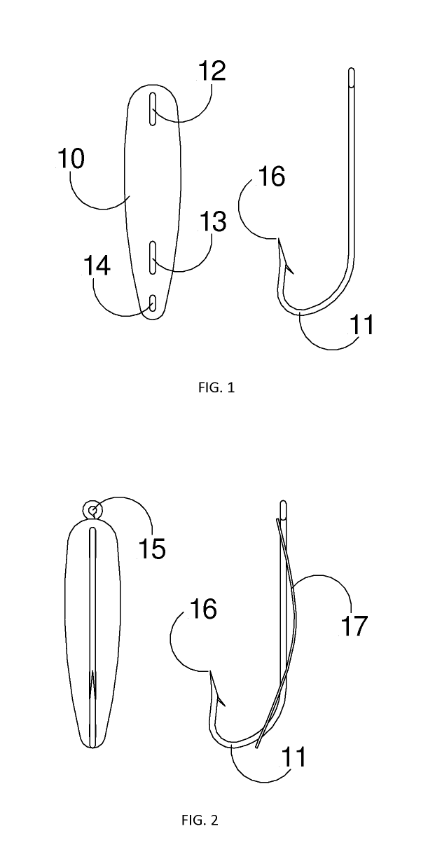

FIG. 1 New invented lure has only two parts, flat stamped spoon body 10 and hook 11

FIG. 2 New invention of the fishing spoon, from left: top view of assembled spoon and side view of assembled spoon

FIG. 3 Prior art fishing spoon for predatory fish

FIG. 4 Prior art fishing spoon for predatory fish, variation

FIG. 5 Assembling procedure (a) to (f)

### REFERENCE NUMERALS IN DRAWINGS

10 Spoon body
11 hook
12 top elongate hole on spoon body
13 middle elongate hole on spoon body
14 bottom elongate hole on spoon body
15 eyehole of hook
16 sharp tip of hook
17 curved spoon body due to rigid hook after assemble
18 diamond shaped prior art spoon body
19 prior art screw through eyehole 15 of hook to tapped hole 22 of spoon body 18
20 hard soldered ring 20 connects between spoon body 18 and leader line
21 top hole 21 of the prior art spoon body 18
22 threaded hole 22 on the prior art spoon body 18
23 bottom hole 23 on the spoon body 18
24 plastic spacer 24 between spoon body 18 and twist eyehole 25
25 twist eye hole 25 for connection to the leader line
26 top hole 26 for plastic spacer 24 and swivel with eyehole 25 connector

### DETAILED DESCRIPTION

The body of spoon has three elongated holes: top 12, middle 13 and bottom 14 holes as shown in FIG. 1 and FIG. 5 (a). The assembling the invented spoon fishing lure is simple without any tool as shown in FIG. 5. The sharp end of hook 16 is inserted in the middle hole 13 from front to back and then through the bottom hole 14 from back to front. The hook is pushed in farther and an eyehole 15 is aligned at the top hole 12. The hook 11 is rotated to 90 degrees and is pushed into the top hole 12 from front to back and through the back side. Then the hook 11 twists back in the last step picture as shown in FIG. 5 (f). Another way of assembling is: A sharp tip of the hook is inserted though the top hole 12 from back to front. Rotate a hook 180 degrees, and through middle 13 from front to back side and rotate the hook 180 degrees, bottom hole 14 from back to front. The body of spoon requires some of the flexibility when assembling but the lure is complete without any tool. The body of spoon is made of white plastic sheet; however, the lure is durable enough for harvesting predatory fish many times without any damage. The curved spoon body 17 mimics a bait fish swimming at high speed when trolling. The action attracts predatory fish to bite. To enhance wobbling action of the spoon, a loop leader connection should be effective. The continuous rotation can be provided using a simple swivel connector to the eyehole of the hook. Trolling using a spoon without a boat can be achieved by casting and retrieving with 60 to 180 grams of a sink followed by a 1-2 meter leader with the lure from piers, shores, or sea walls. The bottom rigger is used from the boat with trolling speed. The role of the sink and the bottom rigger is to keep the lure in the desired depth.

I claim:

1) The fishing spoon lure comprising of a rigid hook attached to the spoon body without any screw or rivet or solder.

2) The fishing spoon lure claim 1, wherein the hook starts inserting the three holes on the spoon body which is a semi-rigid, flat piece without any fastener.

3) The fishing spoon lure claim 1, wherein initially flat spoon body is curved by a rigid hook after assembly.

4) The fishing spoon lure claim 1, wherein the spoon body is made of semi-flexible sheet.

5) The fishing spoon lure claim 1, wherein the semi-rigid sheets are made of metal, plastic and are initially soft but is harden after process.

6) The fishing spoon lure claim 1, wherein the spoon body is covered with paint and metallic coating before and after assembling.

7) The fishing spoon lure claim 1, wherein the spoon body materials include UV, heat, dry, wet and chemical hardening materials.

8) The fishing spoon lure claim 1, wherein the designed hook provides a desirable spoon shape including holding a spoon body in place.

9) The fishing spoon lure claim 1, wherein the damaged part can be replaced without any tool.
